(19) United States
(12) Patent Application Publication
(10) Pub. No.: US 2026/0311035 A1
(43) Pub. Date: Oct. 8, 2026

(54) MODEL TRAINING AND MODEL TRAINING TASK EXECUTION

(71) Applicant: ZHEJIANG LAB, Hangzhou, Zhejiang (CN)

(72) Inventors: Wen CHENG, Hangzhou, Zhejiang (CN); Yong LI, Hangzhou, Zhejiang (CN); Yi LIU, Hangzhou, Zhejiang (CN); Chenshu HU, Hangzhou, Zhejiang (CN); Lingfang ZENG, Hangzhou, Zhejiang (CN)

(73) Assignee: ZHEJIANG LAB, Hangzhou, Zhejiang (CN)

(21) Appl. No.: 19/150,176

(22) PCT Filed: May 21, 2025
(86) PCT No.: PCT/CN2025/096341

§ 371 Date: Jul. 22, 2025

(30) Foreign Application Priority Data
Apr. 2, 2025 (CN) 202510404732.5

(51) Int. Cl. G06N 20/00

(52) U.S. Cl. CPC G06N 20/00

(57) ABSTRACT

The present disclosure discloses model training systems, methods and apparatuses for executing model training tasks, and media. The management cluster in the model training system can obtain real-time status data of the training cluster when executing the model training task. Through this real-time status data, the status of the training cluster during the execution of the model training task within a future set time period is predicted. The management cluster determines the simulators corresponding to the devices in the training cluster, and initializes the virtual training cluster corresponding to the training cluster through these simulators. Based on the predicted status, the management cluster generates execution strategies for the virtual training cluster, and executes the model training task through virtual training cluster simulation according to at least some of these execution strategies, obtaining performance indicators corresponding to at least some of the execution strategies. Based on the obtained performance indicators, the target strategy is determined to execute the model training task according to the target strategy, thereby effectively improving the efficiency of the entire training cluster.

### TECHNICAL FIELD

The present disclosure relates to the fields of computer technology and artificial intelligence, particularly to model training and model training task execution.

### BACKGROUND

With the continuous development of deep learning technology, the training of large models has gradually become an important engine driving the progress of artificial intelligence technology. Large model training typically requires a significant amount of computing resources and relies on a large high-performance computing cluster (including a GPU (Graphics Processing Unit)/CPU (Central Processing Unit) node, a network switching device, and a storage system) collaborating to complete. However, as the model size and training period continue to grow, the operating statuses of cluster devices becomes increasingly complex, and system performance bottlenecks and device health issues become increasingly prominent. During weeks or even months of continuous training, if a key node fails or experiences severe performance degradation, it often leads to training interruptions, delays, and resource waste.

To avoid the above problems, some scheduling strategies can be adopted to achieve computing resource scheduling, thereby allocating the computing resources required during the training process of the large model. However, in related arts, static or semi-dynamic scheduling strategies are often used in large model training scenarios. These methods generally have the following problems: firstly, it is difficult to capture system status changes in real time, and there is a lack of flexible real-time prediction and quick response means for device health status and performance bottlenecks; secondly, the ability to match tasks with resources is limited, and the scheduling and allocation of training tasks cannot be quickly optimized based on the latest device status information, resulting in poor resource utilization and extended training periods; moreover, there is a lack of low-cost experiments and optimization venues, and attempting different strategies in practical environments is costly (such as pausing training, redeployment, etc.), making it difficult to quickly evaluate the advantages and disadvantages of multiple strategies; finally, in related arts, task scheduling and status/fault management are usually designed as independent modules, lacking a collaborative optimization mechanism between the two, which further limits the overall efficiency of the cluster.

### SUMMARY

The embodiments of the present disclosure provide model training systems, methods and apparatuses for executing model training tasks, and storage media to partially solve the above-mentioned problems in the prior art.

The present disclosure adopts following technical solutions.

The embodiments of the present disclosure provide a model training system, including: a training cluster and a management cluster; where the training cluster is configured to execute a model training task; where the management cluster is configured to: obtain real-time status data of the training cluster when the training cluster executes the model training task, based on the real-time status data, predict status of the training cluster when the training cluster executes the model training task in a future set time period as a predicted status, determine simulators corresponding to devices in the training cluster, to initialize a virtual training cluster corresponding to the training cluster based on the simulators, based on the predicted status, generate execution strategies for the virtual training cluster, simulate the model training task by the virtual training cluster according to at least some of the execution strategies, to obtain performance indicators corresponding to the at least some of the execution strategies, and determine a target strategy from the execution strategies based on the performance indicators corresponding to the at least some of the execution strategies, and according to the target strategy, execute the model training task by the training cluster, where the virtual training cluster uses different virtual devices when simulating the model training task according to different execution strategies, and/or the virtual training cluster uses different data processing strategies when simulating the model training task according to different execution strategies.

Optionally, the model training system further includes: a storage cluster, configured to store real-time status data of the training cluster when the training cluster executes the model training task; where the management cluster is configured to obtain the real-time status data from the storage cluster.

Optionally, the management cluster is configured to: obtain a task parameter corresponding to the model training task, and based on the task parameter and real-time status data, predict the status of the training cluster when the training cluster executes the model training task in the future set time period.

Optionally, the management cluster is configured to: select a candidate execution strategy from the execution strategies, according to the candidate execution strategy, simulate the model training task by the virtual training cluster to obtain a performance indicator corresponding to the candidate execution strategy, and based on the performance indicator corresponding to the candidate execution strategy, reselect a candidate execution strategy from remaining execution strategies until the target strategy is determined.

Optionally, the performance indicator includes: a simulation time period spent on simulating the model training task by the virtual training cluster, a simulation resource utilization rate when the virtual training cluster simulates the model training task, and a simulation load when the virtual training cluster simulates the model training task; where the management cluster is configured to: based on the simulation time period corresponding to the candidate execution strategy and a weight corresponding to the simulation time period, the simulation resource utilization rate corresponding to the candidate execution strategy and a weight corresponding to the simulation resource utilization rate, and the simulation load corresponding to the candidate execution strategy and a weight corresponding to the simulation load, determine a function value of a preset target function, where if the simulation time period is longer, the function value is larger, if the simulation resource utilization rate is larger, the function value is smaller, and if the simulation load is larger, the function value is larger, fit a posterior distribution of the target function based on the function value, and based on the posterior distribution, reselect a candidate execution strategy from remaining execution strategies.

The embodiments of the present disclosure provide a model training task, applied to a management cluster in a model training system, where the model training system further includes a training cluster, and the method includes: obtaining real-time status data of the training cluster when the training cluster executes the model training task; based on the real-time status data, predicting status of the training cluster when the training cluster executes the model training task in a future set time period as a predicted status; determining simulators corresponding to devices in the training cluster, to initialize a virtual training cluster corresponding to the training cluster based on the simulators; based on the predicted status, generating execution strategies for the virtual training cluster, where the virtual training cluster uses different virtual devices when simulating the model training task according to different execution strategies, and/or the virtual training cluster uses different data processing strategies when simulating the model training task according to different execution strategies; simulating the model training task by the virtual training cluster according to at least some of the execution strategies, to obtain performance indicators corresponding to the at least some of the execution strategies, and determining a target strategy from the execution strategies based on the performance indicators corresponding to the at least some of the execution strategies, and according to the target strategy, executing the model training task by the training cluster.

Optionally, based on the predicted status, generating execution strategies for the virtual training cluster, simulating the model training task by the virtual training cluster according to the at least some of the execution strategies, to obtain performance indicators corresponding to the at least some of the execution strategies, and determining the target strategy from the execution strategies based on the performance indicators corresponding to the at least some of the execution strategies includes: selecting a candidate execution strategy from the execution strategies; according to the candidate execution strategy, simulating the model training task by the virtual training cluster to obtain a performance indicator corresponding to the candidate execution strategy; and based on the performance indicator corresponding to the candidate execution strategy, reselecting a candidate execution strategy from remaining execution strategies until the target strategy is determined.

Optionally, the performance indicator includes: a simulation time period spent on simulating the model training task by the virtual training cluster, a simulation resource utilization rate when the virtual training cluster simulates the model training task, and a simulation load when the virtual training cluster simulates the model training task; where based on the performance indicator corresponding to the candidate execution strategy, reselecting the candidate execution strategy from the remaining execution strategies includes: based on the simulation time period corresponding to the candidate execution strategy and a weight corresponding to the simulation time period, the simulation resource utilization rate corresponding to the candidate execution strategy and a weight corresponding to the simulation resource utilization rate, and the simulation load corresponding to the candidate execution strategy and a weight corresponding to the simulation load, determining a function value of a preset target function, where if the simulation time period is longer, the function value is larger, if the simulation resource utilization rate is larger, the function value is smaller, and if the simulation load is larger, the function value is larger; fitting a posterior distribution of the target function based on the function value; and based on the posterior distribution, reselecting a candidate execution strategy from remaining execution strategies.

The embodiments of the present disclosure provide an apparatus for executing a model training task, including: an obtaining module, configured to obtain real-time status data of a training cluster when the training cluster executes the model training task; a prediction module, configured to, based on the real-time status data, predict status of the training cluster when the training cluster executes the model training task in a future set time period as a predicted status; an initialization module, configured to determine simulators corresponding to devices in the training cluster, to initialize a virtual training cluster corresponding to the training cluster based on the simulators; a generating module, configured to, based on the predicted status, generate execution strategies for the virtual training cluster, where the virtual training cluster uses different virtual devices when simulating the model training task according to different execution strategies, and/or the virtual training cluster uses different data processing strategies when simulating the model training task according to different execution strategies; a determining module, configured to simulating the model training task by the virtual training cluster according to at least some of the execution strategies, to obtain performance indicators corresponding to the at least some of the execution strategies, and determining a target strategy from the execution strategies based on the performance indicators corresponding to the at least some of the execution strategies, and an executing module, configured to, according to the target strategy, execute the model training task by the training cluster.

The embodiments of the present disclosure provide a computer-readable storage medium, where the storage medium stores a computer program, and the computer program when executed by a processor implements the above method for executing the model training task.

At least one of the above technical solutions adopted in the embodiments of the present application can achieve the following beneficial effects.

The model training system and the method for executing the model training task are provided in the embodiments of the present disclosure, where the management cluster in the model training system can obtain real-time status data of the training cluster when the training cluster executes the model training task, and then through the real-time status data, predict the status of the training cluster when the training cluster executes the model training task in the future set time period. In addition, the management cluster can determine the simulators corresponding to the devices in the training cluster, and initialize the virtual training cluster corresponding to the training cluster through these simulators. Afterwards, the management cluster can generate execution strategies for the virtual training cluster based on the predicted status, and simulates the model training task by the virtual training cluster according to at least some of these execution strategies, to obtain performance indicators corresponding to the at least some of the execution strategies. Based on the obtained performance indicators, the target strategy can be determined from execution strategies, and the model training task can be executed by the training cluster according to the target strategy.

From the above method, it can be seen that based on the real-time status information of the training cluster executing the model training task, the management cluster in the model training system can predict the status of the training cluster when the training cluster executes the model training task in the future. In addition, the management cluster can create a virtual training cluster corresponding to the training cluster, and simulate execution strategies determined based on the predicted status by the virtual training cluster to determine the optimal target strategy. Then, according to the target strategy, the training cluster can be adjusted or the data processing method of the training cluster executing the model training task can be adjusted. Therefore, the model training system and method provided in the embodiments of the present disclosure can establish an effective prediction mechanism, respond in advance to various situations that may occur during the execution of model training task by the training cluster, to ensure the normal execution of the model training task. Moreover, by creating a virtual training cluster, better execution strategies can be simulated, thereby further improving the efficiency of the entire training cluster in executing the model training task.

### BRIEF DESCRIPTION OF DRAWINGS

FIG. 1 is a schematic structural diagram of a model training system provided in the embodiments of the present disclosure.

FIG. 2 is a schematic diagram of processes for executing a model training task provided in the embodiments of the present disclosure.

FIG. 3 is a schematic diagram of an entire process for executing a model training task in series provided in the embodiments of the present disclosure.

FIG. 4 is a schematic diagram of an apparatus for executing a model training task provided in the embodiments of the present disclosure.

### DETAILED DESCRIPTION

To present the purposes, technical solutions and advantages of the present disclosure clearer, the technical solutions of the present disclosure will be clearly and completely described below in conjunction with specific embodiments and corresponding drawings of the present disclosure. The described embodiments are only a part of the embodiments of the present disclosure, and not all of the embodiments. Other embodiments achieved by those skilled in the art according to the embodiments in the present disclosure without paying creative work shall all fall within the scope of protection of the present disclosure.

The technical solutions provided in the embodiments of the present disclosure are described in detail below in conjunction with the accompanying drawings.

To solve the above problems, the embodiments of the present disclosure provide a model training system, which includes a training cluster and a management cluster. The training cluster is configured to perform a model training task, and the management cluster is configured to perform task scheduling. The task scheduling refers to adjusting the training cluster based on the status of the training cluster executing the model training task, or adjusting the data processing method of the training cluster executing the model training task.

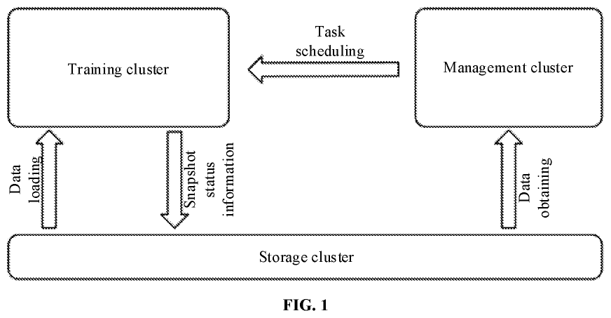

The premise of the management cluster executing the task scheduling is to obtain data for determining the execution strategies corresponding to task scheduling. Therefore, the above model training system further has a storage cluster, where the storage cluster is mainly configured to storing data. The data generated by the training cluster when executing the model training task can be stored in the storage cluster, and the management cluster can obtain the required data from the storage cluster to determine the execution strategies corresponding to task scheduling. The structure of the above model training system is shown in FIG. 1.

FIG. 1 is a schematic structural diagram of a model training system provided in the embodiments of the present disclosure.

From FIG. 1, it can be seen that the model training system provided in the embodiments of the present disclosure mainly includes three parts: the storage cluster, the management cluster, and the training cluster. The management cluster and the training cluster can share the storage cluster, and the storage cluster maintains the data required for the entire process for executing the model training task. Therefore, the data required for the training cluster to execute the model training task can be loaded from the storage cluster, and the status information in the form of snapshots generated by the training cluster during the execution of model training task can be stored in the cluster.

The management cluster obtains the status information generated during the execution of model training task by the training cluster from the storage cluster, and determines the execution strategies based on the status information. Afterwards, the management cluster executes task scheduling based on the determined execution strategies, which ensures the smooth execution of model training task by the training cluster.

In the embodiments of the present disclosure, the training cluster includes multiple high-performance training servers, a computing network switch cluster, and/or an IB (InfiniBand)/Ethernet switch cluster.

Each high-performance training server mainly includes multiple computing units (configured to computing acceleration during model training, such as GPUs), multiple storage units (responsible for storing the data required for executing the model training task), multiple general-purpose computing units (configured for task scheduling, special transcendental function calculation, etc., where general-purpose computing units can refer to CPUs), multiple network interface cards (configured for synchronizing or transmitting data between multiple computing units), and multiple switches (configured for synchronizing or transmitting data between general-purpose computing units, storage units, computing units, and network interface cards).

The computing network switch cluster is mainly configured to high-speed data transmission (such as model parameter synchronization) between various high-performance training servers.

The IB/Ethernet switch cluster, configured to link the storage cluster and the management cluster to achieve data access and task scheduling during model training and execution.

In the embodiments of the present disclosure, the training cluster can be a homogeneous cluster or a heterogeneous cluster. A homogeneous cluster refers to a cluster including devices from the same manufacturer, and a heterogeneous cluster refers to a cluster including devices from different manufacturers. The present disclosure does not limit the specific form of the training cluster.

The management cluster in the model training system can include high-performance CPU servers. Based on the status data of the training cluster when the training cluster executes model training task, the management cluster responds in advance to possible future situations of the training cluster, and explores the optimal execution strategy through the construction of a virtual training cluster, to execute task scheduling for the training cluster, which improves the overall efficiency of model task execution of the training cluster.

The storage cluster in the model training system can include storage servers, responsible for storing various information in the model training system and the data required for the execution of model training task. For example, model parameters, training samples, and other data can be loaded into various high-performance training servers in the training cluster through IB/Ethernet, or real-time status information can be collected from various high-performance training servers in the training cluster when executing the model training task. The file system form based on which the storage cluster stores data is not specifically limited in the embodiments of the present disclosure, and can be various high-performance file systems, such as General Parallel File System (GPFS), Parallel Distributed File System Lustre, etc.

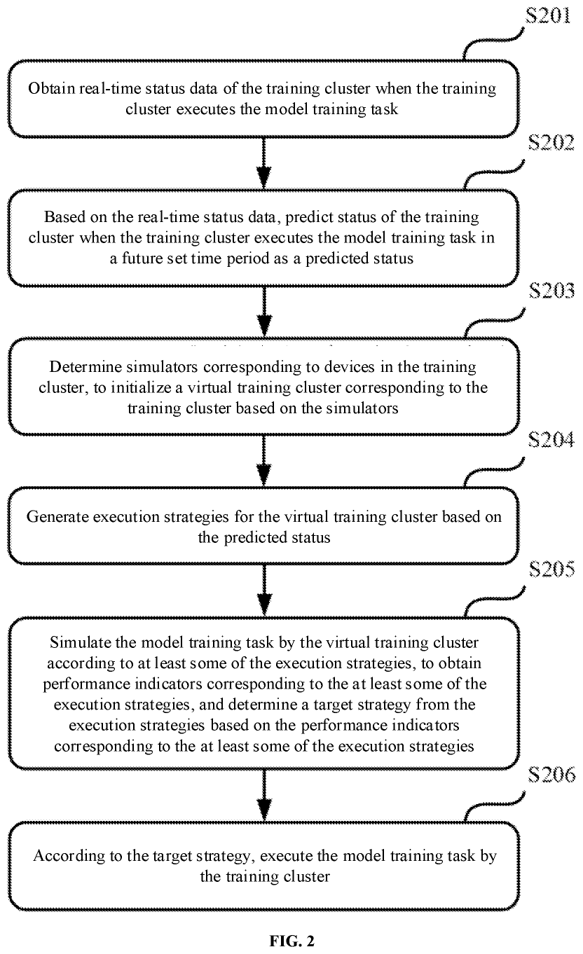

The management cluster, storage cluster, and training cluster in the above model training system work together to complete the execution process of the model training task, which by formulating execution strategies, ensures the efficiency of the entire model training task execution process. The following will provide a detailed explanation of the process of the model training system executing the model training task, as shown in FIG. 2.

FIG. 2 is a schematic diagram of the method for executing a model training task provided in the embodiments of the present disclosure, which includes the following steps S201 to S206.

In S201, real-time status data of the training cluster when the training cluster executes the model training task is obtained.

In the above model training system, the management cluster is responsible for task scheduling for the training cluster. Therefore, in the embodiments of the present disclosure, the management cluster can obtain real-time status data of the training cluster when executing the model training task. The status data mentioned in the embodiments of the present disclosure may include CPU/GPU utilization, storage I/O latency, network throughput, log records, fault records, or other data of the training cluster when executing the model training task. The status data mentioned here can not only reflect the status of the device in the training cluster, but also include the status of the task when the training cluster executes model training task, such as training accuracy, loss value, or training time of the model to be trained, etc.

It should be pointed out that when the management cluster predicts the status of the training cluster during the execution of the model task in the future, in addition to referring to the real-time status data obtained above, the management cluster can also combine the task parameter corresponding to the model training task. The task parameter mentioned here can include the model structure data of the model to be trained, the parameter scale of the model, the size and distribution of the training sample set configured to training the model, or the number of training rounds of the model to be trained, etc.

In addition, the management cluster can further obtain the cluster configuration parameter corresponding to the training cluster. The cluster configuration parameter mentioned here can include the number of devices (such as high-performance training servers, general-purpose computing units, network interface cards, etc. mentioned above) in the training cluster, the type of GPU/CPU (such as the models of GPU or CPU, such as AMD EPYC 9754 128-Core Processor, NVIDIA A100 80 GB PCIe, etc.), the network bandwidth and the network topology structure of the training cluster, the file system type used by the storage cluster, or storage capacity, etc.

Therefore, the management cluster can predict the future status of the training cluster based on the obtained real-time status data, cluster configuration parameter, and task parameter in the subsequent process.

In practical applications, the historical status of the training cluster can also reflect to some extent the future status of the training cluster during the execution of model training task. Therefore, in the embodiments of the present disclosure, in addition to obtaining the aforementioned data, the management cluster can further obtain historical status data of the training cluster. For example, the real-time status data mentioned above refers to the status data generated by the training cluster executing the model training task in the current period, and the historical status data mentioned here can refer to the historical status data generated by the training cluster executing the model training task before the current period.

In some embodiments, the historical status data mentioned above may also include the status data generated by the training cluster during the execution of tasks similar to the model training task in history. Therefore, the management cluster can match the historical tasks similar to the current model training task in the stored execution records of model training tasks based on the task parameter and cluster configuration parameter, to obtain the historical status data of the matched similar tasks as a basis for prediction. Where the execution records of model training tasks can be stored in the above-mentioned storage cluster, and the management cluster can obtain the execution records of model training tasks from the storage cluster.

Furthermore, in the embodiments of the present disclosure, the storage cluster can collect and store status data in real-time or periodically from the logs generated by the model training task executed by the training cluster through preset commands, or collect status data through preset monitoring tools. The present disclosure does not limit the commands or monitoring tools used, as long as they can effectively complete data collection.

In S202, based on the real-time status data, status of the training cluster when the training cluster executes the model training task in a future set time period is predicted as a predicted status.

After obtaining the real-time status data mentioned above, the management cluster can analyse the real-time status data (which can be combined with the task parameter, system configuration parameter, and historical status data) to predict the status of the training cluster when executing the model training task in the future set time period.

The reason why the management cluster requires predicting the status of the training cluster in advance is mainly to prevent device failures such as GPU overheating and server failures, or performance bottlenecks such as network congestion and storage latency during the future execution of the model training task, and to prevent these problems from affecting the smooth execution of the model training task.

Therefore, the management cluster can predict the status of the training cluster from different dimensions through the obtained real-time status data. For example, if the management cluster determines, through the obtained real-time status data, that the network throughput of the training cluster has decreased during the current execution of model training task, the management cluster can predict that the network throughput of the training cluster will further decrease during the future set time period when executing the model training task.

For example, if the management cluster detects, through the obtained real-time status data, that the temperature of some GPUs in the training cluster has increased during the current execution of model training task, the management cluster can predict that some GPUs in the training cluster will overheat during the future set time period when executing the model training task.

For example, if the management cluster determines, based on the obtained real-time status data, that the speed of writing data generated by the training cluster during the current execution of model training task to the storage cluster has decreased, the management cluster can predict that the data generated by the training cluster during the future set time period may not be able to be properly written to the storage cluster for storage.

The examples listed above use single dimensional data to predict the future status of the training cluster. In practical applications, the management cluster can combine data from multiple dimensions to predict the future status of the training cluster.

For example, if the management cluster determines, through the obtained real-time status data, that the GPU temperature of a high-performance training server in the training cluster has significantly increased, and based on the GPU type of the high-performance training server, the management cluster determines that the computing power that the high-performance training server can improve is lower compared to another training server, and the bandwidth on which the high-performance training server transmits data during the model training task is lower, the management cluster can predict that the high-performance training server may experience operational failures in the future set time period. Other examples will not be illustrated here.

The above management cluster predicts the future status of the training cluster based on the obtained data, which can be understood as the management cluster achieving prediction through various preset rules. If an artificial intelligence model that can predict the future status of the training cluster is pre-deployed in the management cluster, the management cluster can also input the obtained data into the artificial intelligence model, and output the status of the training cluster when the training cluster executes the model training task within a future set time period by the artificial intelligence model. The artificial intelligence model mentioned here can be any model that can achieve the prediction function, and the present disclosure does not limit the specific form of the artificial intelligence model.

In addition, when the management cluster predicts the status of the training cluster, the predicted status can be recorded, to determine the execution strategies by the stored predicted status for the training cluster to execute the model training task within a future set time period.

In S203, simulators corresponding to devices in the training cluster are determined, to initialize a virtual training cluster corresponding to the training cluster based on the simulators.

To ensure the smooth execution of the model training task by the training cluster within a future set time period, the management cluster needs to determine the execution strategies for the training cluster based on the predicted status obtained. To ensure the feasibility of executing the strategy and meet the actual situation of the training cluster in the future set time period, in the embodiments of the present disclosure, the management cluster can construct a virtual training cluster that is basically consistent in architecture and function with the training cluster. The virtual training cluster does not include real cluster devices, but can be implemented through simulators.

Therefore, the management cluster can determine the simulators corresponding to the devices in the training cluster based on the configuration information and architecture information of the training cluster, and then initialize the virtual training cluster corresponding to the training cluster based on these simulators.

The management cluster can use a computing simulator to simulate the computing unit in the high-performance training server mentioned above, and use a storage simulator to simulate the storage unit in the high-performance training server mentioned above; by computing a network simulator, the various computing units simulated by the computing simulators can be interconnected to form a data transmission network (such as a Scale-Up network); through the network simulator, the computing units simulated by the computing simulators and the storage units simulated by the storage simulators can be interconnected to construct a virtual high-performance training server; and a data transmission network (such as a Scale-Out network) can be constructed through the network simulator, to build a virtual training cluster.

It should be pointed out that in practical applications, the management cluster does not necessarily need to initialize the virtual training cluster corresponding to the training cluster after determining the predicted status mentioned above. As the configuration information and architecture information of the training cluster can be obtained in advance, the management cluster can actually initialize the virtual training cluster corresponding to the training cluster before determining the predicted status mentioned above, or initialize the virtual training cluster corresponding to the training cluster before obtaining the real-time status data mentioned above. In short, the present disclosure does not make limitations on the timing of initializing the virtual training cluster.

In S204, execution strategies for the virtual training cluster are generated based on the predicted status.

After building the virtual training cluster mentioned above, the management cluster can generate the execution strategies for the virtual training cluster based on the predicted status and the actual situation of the training cluster. In fact, the execution strategies are also generated for the training cluster.

The execution strategies generated by the management cluster mainly comes from two perspectives. One is aimed at the devices of the training cluster, that is, it is determined, based on the actual situation of the training cluster when executing the model training task, whether there is a device in the training cluster with a risk of failure during the future set time period; alternatively, based on the actual situation of the training cluster when executing the model training task, it is determined whether it is necessary to increase or decrease the number of devices in the training cluster, or modify the entire topology structure of the training cluster to adapt to the execution of the model task.

Where the above-mentioned increase in devices can cope with the situation of insufficient computing power resources, that is, idle devices (such as computing unit GPUs) in the training cluster can be enabled to improve the computing power resources during the execution of the model training task. Reducing the number of devices can cope with situations where there are sufficient computing power resources, that is, some devices (such as computing unit GPUs) that have already been started in the training cluster can be disabled to save these computing power resources, and can be configured to other model training tasks.

The above mentioned mainly focuses on the execution strategies for the devices in the training cluster, and the management cluster can also generate the execution strategies from the perspective of data processing for the model training task. The execution strategies generated from the perspective of data processing for the model training task can be implemented from various perspectives, such as changing data slicing methods, checkpoint intervals, parallelism settings, or load balancing strategies, etc.

Where data slicing refers to the method of slicing a dataset or model parameters into multiple computing nodes (such as GPUs, servers) according to specific strategies, with the aim of improving computing efficiency, scalability, or resource utilization. The management cluster can determine, based on the obtained predicted status, which splitting strategy should be configured to allocate the dataset or model parameters to each computing unit in the training cluster within a future set time period.

The checkpoint interval refers to the time interval between two consecutive checkpoint operations. The core function of the checkpoint interval is to achieve fault tolerance and rapid recovery by regularly saving the status of the model or task, which can avoid data loss or retraining caused by failures or interruptions. The status of the training cluster in the future set time period determines how long the checkpoint interval is configured to save the status of the model or task. For example, if the training cluster is prone to abnormal situations such as failures in the future set time period, the checkpoint interval should be set relatively small to ensure that the saved model or task status can be as close as possible to the time point of failure in case of abnormal situations such as failures; and if the training cluster is not prone to abnormal situations such as failures within a future set time period, the checkpoint interval can be set to be larger to save resources as much as possible.

Parallelism setting refers to a parameter that controls the number of computing tasks or threads that are executed simultaneously, with the aim of improving task efficiency through the rational utilization of computing resources such as CPU, GPU, and nodes. For example, if the task execution progress of the training cluster is hindered within a future set time period, the parallelism can be improved by increasing the number of threads to enhance task efficiency. If the training cluster has sufficient number of task execution threads within a future set time period, the number of threads used can be reduced without affecting the normal execution of the model training task to save resources.

The load balancing strategy refers to a series of methods that optimize resource utilization, improve system performance, and avoid single point overload by reasonably allocating tasks or traffic to multiple GPUs, servers, or other devices. The core goal of the load balancing strategy is to ensure that the loads of all devices is balanced as much as possible, thereby improving task execution efficiency, reducing latency, and enhancing system reliability and scalability.

In this regard, the management cluster can adjust the allocation strategy of the training cluster when executing the model training task within a future set time period based on the determined predicted status, evenly distribute the data required for task execution to each device, avoid the occurrence of single point overload, and ensure the smooth execution of the model training task.

In some embodiments, the execution strategies determined from the perspective of data processing for model training task also includes other aspects, which will not be illustrated here.

Therefore, as can be seen from the above content, since the management cluster initializes the virtual training cluster corresponding to the training cluster, the execution strategies generated by the management cluster is for the virtual training cluster. From a device perspective, the virtual training cluster actually uses different virtual devices to execute model training task according to different execution strategies. However, from a data processing perspective, the virtual training cluster actually uses different data processing strategies when executing the model training task according to different execution strategies.

In addition, in practical applications, the management cluster can also generate execution strategies from both device and data processing perspectives. At this point, the determined execution strategies not only include adjustments to virtual devices or the topology structure of the virtual training cluster, but also involve adjustments to the data processing strategies used during the execution of the model training task. Specifically, depending on the actual situation, the management cluster needs to generate execution strategies for the virtual training cluster (i.e., training cluster) based on the determined predicted status.

In S205, the model training task is simulated by the virtual training cluster according to at least some of the execution strategies, to obtain performance indicators corresponding to the at least some of the execution strategies, and a target strategy is determined from the execution strategies based on the performance indicators corresponding to the at least some of the execution strategies.

After generating execution strategies for the virtual training cluster, the management cluster needs to follow these execution strategies and simulate the execution of the model training task by the virtual training cluster, determine the final target strategy to be executed from these execution strategies.

In this process, the management cluster needs to first synchronize the status of the virtual training cluster according to the current execution status of the model training task. Then, the management cluster can execute, by the virtual training cluster, the model training task according to each execution strategy, to obtain the performance indicator generated after executing the model training task according to each execution strategy.

The above performance indicator is configured to measure the performance of the virtual training cluster (which is equivalent to the training cluster) in executing the model training task. Specifically, the performance indicator can be measured from three aspects: the time spent on executing the model training task, the resource utilization rate during the model training task, and the load during the model training task.

The time spent is desirable to be shorter, which indicates a higher efficiency in executing the model training task. The resource utilization is desirable to be higher, which indicates that the model training task has fully utilized the available computing resources, network resources, etc., ensuring efficiency and avoiding resource waste as much as possible. The loads are desirable to be more balanced, to prevent situations where a single device is overloaded.

In the embodiments of the present disclosure, there is a target function for the management cluster, and the management cluster can calculate the function value of the target function through the performance indicators of the three aspects mentioned above. Based on the calculated function value, the final target strategy can be determined from various execution strategies.

Specifically, for the performance indicators of the three aspects mentioned above, each performance indicator is assigned a corresponding weight. Based on this, for any one of execution strategies, the management cluster can perform weighted sum, to obtain the function value of the preset target function, on the simulation time period (where the simulation time period refers to the time spent by the virtual training cluster simulating the execution of the model training task according to the execution strategy) corresponding to the execution strategy and the weight corresponding to the simulation time period, the simulation resource utilization rate (where the simulation resource utilization rate refers to the resource utilization rate of the virtual training cluster simulating the execution of the model training task according to the execution strategy) corresponding to the execution strategy and the weight corresponding to the simulation resource utilization rate, and the simulation load (where the simulation load refers to the load of the virtual training cluster when simulating the execution of the model training task according to the execution strategy) corresponding to the execution strategy and the weight corresponding to the simulation load. The following formula can be referred to for details.

$$Objecttive = {T}_{weight} \times {training}_{time} + {U}_{weight} \times ( 1 - {resource}_{utilization} ) + {L}_{weight} \times {load}_{balancing}$$

Where trainingₜᵢₘₑ represents the simulation time period, T_{weight} represents the weight corresponding to the simulation time period, resource_{utilization} represents the simulation resource utilization rate, U_{weight} represents the weight corresponding to the simulation resource utilization rate, load_{balancing} represents the simulation load, L_{weight} represents the weight corresponding to the simulation load, and Objecttive represents the calculated function value of the target function.

From the above formula, it can be seen that the simulation time period is positively correlated with the function value of the target function, that is, if the simulation time period is larger, the function value is larger, and if the simulation time period is smaller, the function value is smaller. The simulation resource utilization rate is negatively correlated with the function value of the target function, that is, if the simulation resource utilization rate is higher, the function value is lower, and if the simulation resource utilization rate is lower, the function value is higher. The simulation load is positively correlated with the function value of the target function, that is, the larger the simulation load, the larger the function value, and the smaller the simulation load, the smaller the function value.

Therefore, after calculating the function value corresponding to each execution strategy of the management cluster, the final target strategy can be determined based on the function value. In some embodiments, the function value corresponding to the target strategy is the smallest.

In some embodiments, due to the large number of execution strategies generated by the management cluster, blindly executing simulations according to each execution strategy one by one may consume excessive time and resources. Therefore, in the embodiments of the present disclosure, the management cluster can explore the final target strategy step by step without executing all execution strategies.

Specifically, the management cluster can first select a candidate execution strategy from multiple generated execution strategies, and then simulate the model training task through the virtual training cluster according to the candidate execution strategy, to obtain the performance indicator corresponding to the candidate execution strategy. Afterwards, based on the performance indicator corresponding to the candidate execution strategy, the management cluster can re-select a candidate execution strategy from the remaining execution strategies, and repeat the previous process until the final target strategy is selected.

Where the candidate execution strategy selected by the management cluster from the multiple execution strategies mentioned above can include multiple execution strategies, and these candidate execution strategies can serve as initial data for the proxy model. The proxy model mentioned here can be a Gaussian model.

The management cluster uses this proxy model to fit the posterior distribution of the target function based on the initial data mentioned above. This posterior distribution can reflect the predicted value of each of remaining execution strategies, where the predicted value mainly includes two aspects: the predicted mean and the predicted variance.

Where the predicted mean reflects the difference between different execution strategies. If the difference between the means of two execution strategies is too large, it indicates that the difference between these two execution strategies is too large. Conversely, if the difference between the means of two execution strategies is small, it indicates that the difference between these two execution strategies is relatively small.

The predicted variance is configured to reflect the uncertainty of the execution strategies, and the uncertainty can be understood as the uncertainty of whether the execution strategy is the current optimal strategy.

Therefore, after fitting the posterior distribution mentioned above, the management cluster can first determine the current optimal execution strategy by calculating the function value of the target function among the selected candidate execution strategies. Then, through the fitted posterior distribution, one or more candidate execution strategies can be re-selected from the remaining execution strategies to determine the mean difference and variance difference between the re-selected candidate execution strategy and the current optimal execution strategy. For the re-selected candidate execution strategies, the management cluster can select the one with the smallest mean difference with the current optimal execution strategy, or the one with the largest variance difference with the current optimal execution strategy when the mean difference is similar for each candidate execution strategy. Selecting the one with the smallest mean difference is based on the current optimal execution strategy, and selecting an execution strategy that is close to this execution strategy. When the mean difference is similar, selecting the one with the variance difference is a further exploration of the optimal solution.

After re-selecting a candidate execution strategy based on the posterior distribution fitted above, the re-selected candidate execution strategy can be added to the initial data of the proxy model. Based on the updated initial data, the posterior distribution of the target function can be adjusted or re-fitted. Based on the adjusted or re-fitted posterior distribution, a candidate execution strategy can be re-selected from the remaining execution strategies.

Through continuous iteration, the final target strategy can be determined from various execution strategies. In this way, the management cluster does not require calculating the function value of the target function for all execution strategies, which is equivalent to fitting a posterior distribution for exploring the optimal target strategy by first determining the function value of the target functions for some execution strategies. Through this posterior distribution, the final target strategy can be gradually explored, greatly improving the efficiency of determining the target strategy and saving resources to a large extent.

In addition, the setting of the above weights can be determined according to actual needs. For example, if the training time period is the main target, the weights corresponding to the simulation time period can be set relatively large, and the simulation resource utilization rate and simulation load are secondary and auxiliary objectives.

It should be emphasized that the virtual training cluster mentioned above does not actually execute the model training task according to the generated execution strategy. This process is actually a simulation process that needs to be simulated according to the current actual status of the training cluster to execute the model training task.

In addition, in practical applications, the management cluster can also determine whether to calculate the function value corresponding to each execution strategy one by one to determine the target strategy, or explore the target strategy by calculating the function value of a portion of the execution strategies based on the number of generated execution strategies. Specifically, a quantity threshold can be used. When the number of generated execution strategies exceeds this threshold, the target strategy can be explored by calculating the function values of a portion of the execution strategies. If the number of generated execution strategies does not exceed this threshold, the final target strategy can be determined by calculating the function value corresponding to each execution strategy one by one.

In S206, according to the target strategy, the model training task is executed by the training cluster.

After determining the target strategy, the management cluster can perform task scheduling on the training cluster according to the target strategy, adjust the use of devices in the training cluster (such as removing or replacing devices that may fail in the future set time period, or adding devices, etc.), or adjust the data processing method configured to execute the model training task in the future set time period (such as adjusting data slicing methods, etc.). The training cluster can continue to execute the model training task according to the target strategy.

In addition, after the training cluster continues to execute the model training task according to the target strategy for a period of time, the management cluster can continue to obtain real-time status data of the training cluster, and thus continue to determine the target strategy suitable for the training cluster and the model training task to be executed in the above way, such that the training cluster can complete the model training task through the target strategy determined by the management cluster every period of time.

From the above method, it can be seen that based on the real-time status information of the training cluster executing the model training task, the management cluster in the model training system can predict the status of the training cluster when the training cluster executes the model training task in the future. In addition, the management cluster can create a virtual training cluster corresponding to the training cluster, and simulate execution strategies determined based on the predicted status by the virtual training cluster to determine the optimal target strategy. Then, according to the target strategy, the training cluster can be adjusted or the data processing method of the training cluster executing the model training task can be adjusted. Therefore, the model training system and method provided in the embodiments of the present disclosure can establish an effective prediction mechanism, respond in advance to various situations that may occur during the execution of model training task by the training cluster, to ensure the normal execution of the model training task. Moreover, by creating a virtual training cluster, better execution strategies can be simulated, thereby further improving the efficiency of the entire training cluster in executing the model training task.

Moreover, when determining the target strategy, the management cluster can explore the final target strategy through the above-mentioned exploration method, without the need to calculate the function value of the target function for each execution strategy one by one, thereby further improving the efficiency of determining the execution strategy and overall enhancing the efficiency of the training cluster in executing the model training task.

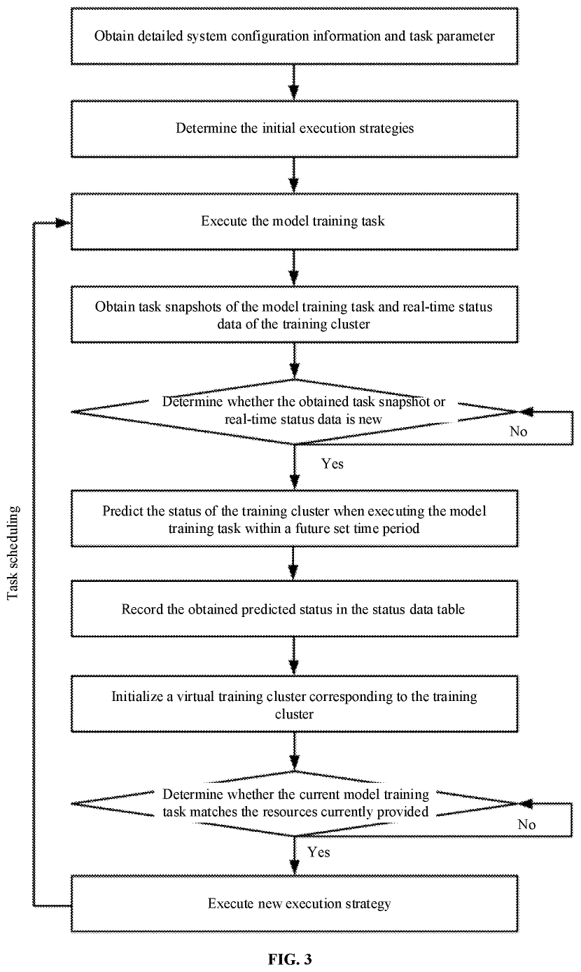

To further describe the method for executing the model training task provided in the embodiments of the present disclosure, the following steps will be connected in series to further explain the entire process, as shown in FIG. 3.

FIG. 3 is a schematic diagram of an entire process for executing a model training task in series provided in the embodiments of the present disclosure.

Before executing the model training task, the management cluster can obtain detailed system configuration information and task parameter from the storage cluster. The task parameter has been explained in the above content and will not be repeated here. The detailed system configuration information is similar to the cluster configuration parameter mentioned above, mainly configured to describe the scale of devices, the types of devices, topology structures, etc. of the entire model training system in detail.

The management cluster can determine the initial execution strategies based on the detailed system configuration information and task parameter obtained, and execute the model training task by the training cluster according to this initial execution strategies.

Afterwards, the management cluster can periodically obtain task snapshots of the model training task and real-time status data of the training cluster from the storage cluster. Where task snapshots can reflect the execution status of the model training task, such as task execution progress, task time consumption, etc. Moreover, it is necessary to further determine whether the obtained task snapshot or real-time status data is new data. As the storage cluster needs to collect the actual status and task snapshot of the training cluster according to a certain collection period, the management cluster need to determine whether the data obtained from the storage cluster is new. If not, it means that the data has already been obtained before. Therefore, it is possible to wait for a period of time before obtaining the task snapshot and status data from the storage cluster.

After determining that the obtained task snapshot and status data are new data, the management cluster can predict the status (i.e., obtain the predicted status) of the training cluster when executing the model training task within a future set time period based on the obtained data, and record the obtained predicted status in the status data table.

Afterwards, the management cluster can initialize a virtual training cluster corresponding to the training cluster and synchronize the status of the virtual training cluster with the current status of the training cluster. The management cluster can generate multiple execution strategies based on the determined predicted status, and determine the final target strategy from these execution strategies through the simulation by the virtual training cluster.

When it is determined through the determined target strategy that the current model training task does not match (this current mismatch reflects that the training cluster may not be able to execute the model training task normally within a future set time period) the resources currently provided by the training cluster, a new execution strategy, namely the target strategy, can be executed to schedule the execution tasks for the training cluster.

By continuously repeating the above process, the device configuration and data processing method of the training cluster can be adjusted to adapt to the model training task and ensure the smooth execution of the model training task.

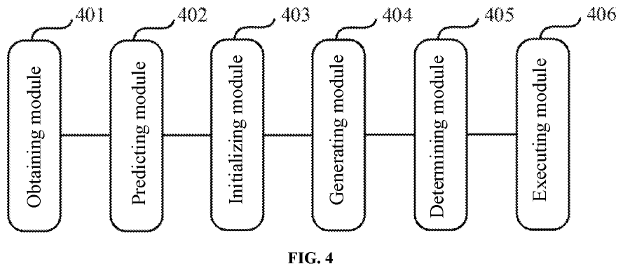

The above is the method for executing the model training task provided by one or more embodiments of the present disclosure. Based on the same idea, the present disclosure further provides a corresponding apparatus for executing the model training task, as shown in FIG. 4.

FIG. 4 is a schematic diagram of an apparatus for executing a model training task provided in the embodiments of the present disclosure. The apparatus includes:
an obtaining module 401, configured to obtain real-time status data of a training cluster when the training cluster executes the model training task;
a prediction module 402, configured to, based on the real-time status data, predict status of the training cluster when the training cluster executes the model training task in a future set time period as a predicted status;
an initialization module 403, configured to determine simulators corresponding to devices in the training cluster, to initialize a virtual training cluster corresponding to the training cluster based on the simulators;
a generating module 404, configured to, based on the predicted status, generate execution strategies for the virtual training cluster, where the virtual training cluster uses different virtual devices when simulating the model training task according to different execution strategies, and/or the virtual training cluster uses different data processing strategies when simulating the model training task according to different execution strategies;
a determining module 405, configured to simulating the model training task by the virtual training cluster according to at least some of the execution strategies, to obtain performance indicators corresponding to the at least some of the execution strategies, and determining a target strategy from the execution strategies based on the performance indicators corresponding to the at least some of the execution strategies, and
an executing module 406, configured to, according to the target strategy, execute the model training task by the training cluster.

Optionally, the prediction module 402 is configured to: obtain a task parameter corresponding to the model training task; and based on the task parameter and real-time status data, predict the status of the training cluster when the training cluster executes the model training task in the future set time period.

Optionally, the determining module 405 is configured to: select a candidate execution strategy from multiple strategies, according to the candidate execution strategy, simulate the model training task by the virtual training cluster to obtain a performance indicator corresponding to the candidate execution strategy, and based on the performance indicator corresponding to the candidate execution strategy, reselect a candidate execution strategy from remaining execution strategies until the target strategy is determined.

Optionally, the performance indicator includes: a simulation time period spent on simulating the model training task by the virtual training cluster, a simulation resource utilization rate when the virtual training cluster simulates the model training task, and a simulation load when the virtual training cluster simulates the model training task.

The determining module 405 is specifically configured to, based on the simulation time period corresponding to the candidate execution strategy and a weight corresponding to the simulation time period, the simulation resource utilization rate corresponding to the candidate execution strategy and a weight corresponding to the simulation resource utilization rate, and the simulation load corresponding to the candidate execution strategy and a weight corresponding to the simulation load, determining a function value of a preset target function, where if the simulation time period is longer, the function value is larger, if the simulation resource utilization rate is larger, the function value is smaller, and if the simulation load is larger, the function value is larger; and fit the posterior distribution of the target function based on the function value, and re-select a candidate execution strategy from the remaining execution strategies based on the posterior distribution.

The embodiments of the present disclosure further provide a computer-readable storage medium storing a computer program that can be configured to execute the method for executing the model training task provided in FIG. 1.

Of course, in addition to the software implementation, the present disclosure does not exclude other implementation methods, such as logic devices or a combination of hardware and software, etc. That is, the executive of the following processing process is not limited to individual logic units, but can also be hardware or logic devices.

In the 1990s, it was clear that improvements to a technology could be distinguished between hardware improvements (e.g., improvements to circuit structures such as diodes, transistors, switches, etc.) and software improvements (improvements to a method flow). However, with the development of technology, currently, the improvements of many method flows can be regarded as the direct improvements of the hardware circuit structures. Designers almost always get the corresponding hardware circuit structure by programming the improved method flow into the hardware circuit. Therefore, it cannot be said that a method flow improvement cannot be implemented with a hardware physical module. For example, a Programmable Logic Device (PLD) (e.g., Field Programmable Gate Array (FPGA)) is one such integrated circuit whose logic function is determined by user programming of the device. A digital system is “integrated” on a PLD by the designer's own programming, without the need for a chip manufacturer to design and manufacture a dedicated integrated circuit chip. Moreover, nowadays, instead of making IC chips manually, this programming is mostly implemented by “logic compiler” software, which is similar to the software compiler used for program development and writing, and the original code has to be written in a specific programming language before it is compiled. This is called Hardware Description Language (HDL), and there is not only one HDL, but many kinds, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, Ruby Hardware Description Language (RHDL), etc. Currently, the most commonly used is Very-High-Speed Integrated Circuit Hardware Description Language (VHDL) and Verilog. It should also be clear to those skilled in the art that a hardware circuit implementing the logical method flow can be easily obtained by simply programming the method flow with a little logic in one of the above hardware description languages and programming the method flow into the integrated circuit.

The controller can be implemented in any suitable manner, for example, the controller can take the form of, for example, a microprocessor or processor and a computer readable medium storing computer readable program code (e.g. software or firmware) executable by the (micro) processor, logic gates, switches, Application Specific Integrated Circuit (ASIC), programmable logic controllers and embedded microcontrollers. Examples of the controllers may include, but are not limited to, the following microcontrollers: ARC 625D, Atmel AT91SAM, Microchip PIC18F26K20, and Silicone Labs C8051F320, and memory controllers may also be implemented as part of the control logic of the memory. It is also known to those skilled in the art that, in addition to implementing the controller in a purely computer readable program code manner, it is entirely possible to make the controller perform the same function in the form of logic gates, switches, specialized integrated circuits, programmable logic controllers, embedded microcontrollers, etc. by logically programming the method steps. Thus, such a controller can be considered as a hardware component, and the devices included therein for implementing various functions can also be considered as structures within the hardware component. Or even, the apparatus for implementing various functions can be considered as both a software module for implementing a method and a structure within a hardware component.

The systems, apparatuses, modules, or units elucidated in the above embodiments can be implemented specifically by a computer chip or entity, or by a product with certain functions. An exemplary implementation device is a computer. Specifically, the computer may be, for example, a personal computer, a laptop computer, a cellular phone, a camera phone, a smart phone, a personal digital assistant, a media player, a navigation device, an email device, a gaming console, a tablet computer, a wearable device, or a combination of any of these devices.

For the convenience of description, the above devices are divided into various units according to their functions and described respectively. It is, of course, possible to implement the functions of each unit in the same or multiple software and/or hardware when implementing the present disclosure.

It should be understood by those skilled in the art that embodiments of the present disclosure may be provided as methods, systems, or computer program products. Accordingly, the present disclosure may take the form of an entirely hardware embodiment, an entirely software embodiment, or an embodiment combining software and hardware aspects.

Furthermore, the present disclosure may employ the form of a computer program product implemented on one or more computer-usable storage media (including, but not limited to, disk storage, CD-ROM, optical storage, etc.), where the one or more computer-usable storage media having computer-usable program code.

the present disclosure is described with reference to flowcharts and/or block diagrams of methods, devices (systems), and computer program products according to embodiments of the present disclosure. It is to be understood that each process and/or block in the flowchart and/or block diagram, and the combination of processes and/or blocks in the flowchart and/or block diagram, may be implemented by computer program instructions. These computer program instructions may be provided to a processor of a general-purpose computer, a specialized computer, an embedded processor, or other programmable data processing device to produce a machine such that instructions executed by the processor of the computer or other programmable data processing device produce an apparatus for implementing a function specified in one or more processes of the flowchart and/or one or more blocks of the block diagram.

These computer program instructions may also be stored in a computer-readable memory capable of directing the computer or other programmable data processing device to operate in a particular manner such that the instructions stored in the computer-readable memory produce an article of manufacture including an instruction apparatus that implements the function specified in one or more processes of the flowchart and/or one or more blocks of the block diagram.

These computer program instructions may also be loaded onto a computer or other programmable data processing device such that a series of operational steps are executed on the computer or other programmable device to produce computer-implemented processing such that the instructions executed on the computer or other programmable device provide the steps configured to perform the functions specified in one or more processes of the flowchart and/or one or more blocks of the block diagram.

In an exemplary configuration, the computing device includes one or more processors (CPUs), input/output interfaces, network interfaces, and memory.

Memory may include at least one of non-permanent storage in computer readable media, random access memory (RAM) or non-volatile memory, such as read only memory (ROM) or flash RAM. Memory is an example of a computer readable medium.

Computer readable media include permanent and non-permanent, removable and non-removable media that can be implemented by any method or technology to store information. Information may be computer readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read only memory (CDROM), digital versatile disc (DVD) or other optical storage, magnetic cartridge tape, magnetic tape magnetic disk storage, other magnetic storage device or any other non-transport medium that can be used to store information that can be accessed by a computing device. As defined herein, computer readable media does not include transitory computer readable media, such as modulated data signals and carriers.

It should also be noted that the term “include”, “comprise” or any other variation thereof is intended to cover non-exclusive inclusion, such that a process, method, article, or device that includes a set of elements includes not only those elements, but also other elements that are not explicitly listed, or other elements that are inherent to such a process, method, commodity, or device. Without further limitation, the element defined by the statement “including a . . . ” do not preclude the existence of additional identical elements in the process, method, article, or device that include the element.

It should be understood by those skilled in the art that embodiments of the present disclosure may be provided as methods, systems or computer program products. Accordingly, the present disclosure may take the form of an entirely hardware embodiment, an entirely software embodiment, or an embodiment combining software and hardware aspects.

Furthermore, the present disclosure may employ the form of a computer program product implemented on one or more computer-usable storage media (including, but not limited to, disk storage, CD-ROM, optical storage, etc.), where the one or more computer-usable storage media having computer-usable program code.

The present disclosure may be described in the general context of computer-executable instructions executed by a computer, such as a program module. Generally, a program module includes routines, programs, objects, components, data structures, and the like that perform a specific task or implement a specific abstract data type. The present disclosure may also be practiced in distributed computing environments where tasks are performed by remote processing devices that are connected via a communication network. In distributed computing environments, program modules may be located in local and remote computer storage medium, including storage devices.

The various embodiments in the present disclosure are described in a progressive manner, and the same or similar parts between the various embodiments may be referred to each other, and each embodiment focuses on the differences from other embodiments. In particular, for a system embodiment, since it is basically similar to the method embodiment, the description is relatively simple, and for related parts, please refer to the partial description of the method embodiment.

The above description is only embodiments of the present disclosure and is not intended to limit the present disclosure. For those skilled in the art, various modifications and changes can be made in the present disclosure. Any modification, equivalent replacement, improvement, etc. present the spirit and principle of the present disclosure shall be included in the scope of the claims of the present disclosure.

1. A model training system, comprising: a training cluster and a management cluster;
wherein the training cluster is configured to execute a model training task;
wherein the management cluster is configured to:
obtain real-time status data of the training cluster when the training cluster executes the model training task,
based on the real-time status data, predict status of the training cluster when the training cluster executes the model training task in a future set time period as a predicted status,
determine simulators corresponding to devices in the training cluster, to initialize a virtual training cluster corresponding to the training cluster based on the simulators,
based on the predicted status, generate execution strategies for the virtual training cluster, simulate the model training task by the virtual training cluster according to at least some of the execution strategies, to obtain performance indicators corresponding to the at least some of the execution strategies, and determine a target strategy from the execution strategies based on the performance indicators corresponding to the at least some of the execution strategies, and
according to the target strategy, execute the model training task by the training cluster,
wherein the virtual training cluster uses different virtual devices when simulating the model training task according to different execution strategies, and/or the virtual training cluster uses different data processing strategies when simulating the model training task according to different execution strategies.

2. The model training system according to claim 1, further comprising:
a storage cluster, configured to store the real-time status data of the training cluster when the training cluster executes the model training task;
wherein the management cluster is configured to obtain the real-time status data from the storage cluster.

3. The model training system according to claim 1, wherein the management cluster is configured to:
obtain a task parameter corresponding to the model training task, and
based on the task parameter and the real-time status data, predict the status of the training cluster when the training cluster executes the model training task in the future set time period.

4. The model training system according to claim 1, wherein the management cluster is configured to:
select a candidate execution strategy from the execution strategies,
according to the candidate execution strategy, simulate the model training task by the virtual training cluster to obtain a performance indicator corresponding to the candidate execution strategy, and
based on the performance indicator corresponding to the candidate execution strategy, reselect a candidate execution strategy from remaining execution strategies until the target strategy is determined.

5. The model training system according to claim 4, wherein the performance indicator comprises: a simulation time period spent on simulating the model training task by the virtual training cluster, a simulation resource utilization rate when the virtual training cluster simulates the model training task, and a simulation load when the virtual training cluster simulates the model training task;
wherein the management cluster is configured to:
based on the simulation time period corresponding to the candidate execution strategy and a weight corresponding to the simulation time period, the simulation resource utilization rate corresponding to the candidate execution strategy and a weight corresponding to the simulation resource utilization rate, and the simulation load corresponding to the candidate execution strategy and a weight corresponding to the simulation load, determine a function value of a preset target function, wherein if the simulation time period is longer, the function value is larger, if the simulation resource utilization rate is larger, the function value is smaller, and if the simulation load is larger, the function value is larger,
fit a posterior distribution of the target function based on the function value, and
based on the posterior distribution, reselect a candidate execution strategy from remaining execution strategies.

6. A method for executing a model training task, applied to a management cluster in a model training system, wherein the model training system further comprises a training cluster, and the method comprises:
obtaining real-time status data of the training cluster when the training cluster executes the model training task;
based on the real-time status data, predicting status of the training cluster when the training cluster executes the model training task in a future set time period as a predicted status;
determining simulators corresponding to devices in the training cluster, to initialize a virtual training cluster corresponding to the training cluster based on the simulators;
based on the predicted status, generating execution strategies for the virtual training cluster, wherein the virtual training cluster uses different virtual devices when simulating the model training task according to different execution strategies, and/or the virtual training cluster uses different data processing strategies when simulating the model training task according to different execution strategies;
simulating the model training task by the virtual training cluster according to at least some of the execution strategies, to obtain performance indicators corresponding to the at least some of the execution strategies, and determining a target strategy from the execution strategies based on the performance indicators corresponding to the at least some of the execution strategies, and
according to the target strategy, executing the model training task by the training cluster.

7. The method according to claim 6, wherein based on the predicted status, generating execution strategies for the virtual training cluster, simulating the model training task by the virtual training cluster according to the at least some of the execution strategies, to obtain performance indicators corresponding to the at least some of the execution strategies, and determining the target strategy from the execution strategies based on the performance indicators corresponding to the at least some of the execution strategies comprises:
selecting a candidate execution strategy from the execution strategies;
according to the candidate execution strategy, simulating the model training task by the virtual training cluster to obtain a performance indicator corresponding to the candidate execution strategy; and
based on the performance indicator corresponding to the candidate execution strategy, reselecting a candidate execution strategy from remaining execution strategies until the target strategy is determined.

8. The method according to claim 7, wherein the performance indicator comprises: a simulation time period spent on simulating the model training task by the virtual training cluster, a simulation resource utilization rate when the virtual training cluster simulates the model training task, and a simulation load when the virtual training cluster simulates the model training task;
wherein based on the performance indicator corresponding to the candidate execution strategy, reselecting the candidate execution strategy from the remaining execution strategies comprises:
based on the simulation time period corresponding to the candidate execution strategy and a weight corresponding to the simulation time period, the simulation resource utilization rate corresponding to the candidate execution strategy and a weight corresponding to the simulation resource utilization rate, and the simulation load corresponding to the candidate execution strategy and a weight corresponding to the simulation load, determining a function value of a preset target function, wherein if the simulation time period is longer, the function value is larger, if the simulation resource utilization rate is larger, the function value is smaller, and if the simulation load is larger, the function value is larger;
fitting a posterior distribution of the target function based on the function value; and
based on the posterior distribution, reselecting a candidate execution strategy from remaining execution strategies.

9. (canceled)

10. A computer readable storage medium, wherein the storage medium stores a computer program, and the computer program when executed by one or more processors implements a method for executing a model training task, applied to a management cluster in a model training system, wherein the model training system further comprises a training cluster, the method comprising:
obtaining real-time status data of the training cluster when the training cluster executes the model training task;
based on the real-time status data, predicting status of the training cluster when the training cluster executes the model training task in a future set time period as a predicted status;
determining simulators corresponding to devices in the training cluster, to initialize a virtual training cluster corresponding to the training cluster based on the simulators;
based on the predicted status, generating execution strategies for the virtual training cluster, wherein the virtual training cluster uses different virtual devices when simulating the model training task according to different execution strategies, and/or the virtual training cluster uses different data processing strategies when simulating the model training task according to different execution strategies;
simulating the model training task by the virtual training cluster according to at least some of the execution strategies, to obtain performance indicators corresponding to the at least some of the execution strategies, and determining a target strategy from the execution strategies based on the performance indicators corresponding to the at least some of the execution strategies; and
according to the target strategy, executing the model training task by the training cluster.

11. The storage medium according to claim 10, wherein based on the predicted status, generating execution strategies for the virtual training cluster, simulating the model training task by the virtual training cluster according to the at least some of the execution strategies, to obtain performance indicators corresponding to the at least some of the execution strategies, and determining the target strategy from the execution strategies based on the performance indicators corresponding to the at least some of the execution strategies comprises:
selecting a candidate execution strategy from the execution strategies;
according to the candidate execution strategy, simulating the model training task by the virtual training cluster to obtain a performance indicator corresponding to the candidate execution strategy; and
based on the performance indicator corresponding to the candidate execution strategy, reselecting a candidate execution strategy from remaining execution strategies until the target strategy is determined.

12. The storage medium according to claim 11, wherein the performance indicator comprises: a simulation time period spent on simulating the model training task by the virtual training cluster, a simulation resource utilization rate when the virtual training cluster simulates the model training task, and a simulation load when the virtual training cluster simulates the model training task;
wherein based on the performance indicator corresponding to the candidate execution strategy, reselecting the candidate execution strategy from the remaining execution strategies comprises:
based on the simulation time period corresponding to the candidate execution strategy and a weight corresponding to the simulation time period, the simulation resource utilization rate corresponding to the candidate execution strategy and a weight corresponding to the simulation resource utilization rate, and the simulation load corresponding to the candidate execution strategy and a weight corresponding to the simulation load, determining a function value of a preset target function, wherein if the simulation time period is longer, the function value is larger, if the simulation resource utilization rate is larger, the function value is smaller, and if the simulation load is larger, the function value is larger;
fitting a posterior distribution of the target function based on the function value; and
based on the posterior distribution, reselecting a candidate execution strategy from remaining execution strategies.
